(19) United States
(12) Patent Application Publication
(10) Pub. No.: US 2021/0220958 A1
(43) Pub. Date: Jul. 22, 2021

(54) METHOD OF MANUFACTURING AN OPTICAL SYSTEM WITH AN OPTICAL COMPONENT MADE OF A BRITTLE-HARD MATERIAL

(71) Applicant: Fraunhofer-Gesellschaft zur Forderung der angewandten Forschung e. V., München (DE)

(72) Inventors: Matthias BEIER, Jena (DE); Stefan RISSE, Jena (DE); Andreas GEBHARDT, Jena (DE)

(73) Assignee: Fraunhofer-Gesellschaft zur Förderung der angewandten Forschung e. V., München (DE)

(21) Appl. No.: 17/255,999

(22) PCT Filed: Jul. 3, 2019
(86) PCT No.: PCT/EP2019/067866

§ 371 Date: Dec. 23, 2020

(30) Foreign Application Priority Data
Jul. 11, 2018 (DE) 102018116816.0

(51) Int. Cl. B24B 13/06; C03C 19/00

(52) U.S. Cl. CPC B24B 13/06; C03C 19/00

(57) ABSTRACT

A method for manufacturing an optical system with an optical component made of a brittle-hard material is described, comprising the steps of; producing at least one optical functional surface at the optical component; mounting of the optical component on a processing machine and producing several reference surfaces and mounting surfaces at the optical component or at least one insert body permanently connected to the optical component by at least one machining tool of the processing machine; measuring the shape and position of the optical functional surface in a coordinate system related to the reference surfaces; performing a correction machining at least once, in which the shape and position deviation of the optical functional surface relative to the reference and mounting surfaces is reduced; and installation of the optical component in a housing structure of the optical system at the mounting surfaces.

The invention relates to a method of manufacturing an optical system with an optical component comprising a brittle-hard material such as a glass, a ceramic or a glass-ceramic.

This patent application claims the priority of the German patent application 10 2018 116 816.0, the disclosure content of which is hereby incorporated by reference.

Optical imaging lens or mirror systems with high demands on image quality are used, for example, in high-precision optical instruments in astronomy, earth observation and remote sensing, precision metrology and microlithography. The imaging quality of the optical system is decisively influenced by the optical and mechanical system design as well as the achievable manufacturing and assembly qualities of the optical surfaces in the beam path. With increasing complexity of the surface geometries as well as increasing imaging qualities, the effort for system assembly also increases. There is therefore a need for methods to simplify the system integration of complex optical systems.

State of the art methods of micromachining are known for the machining of optical high quality components. Besides the machining of the optical surface, these methods allow the machining of measuring, system and assembly structures in the same machine setup. In the publication DE 10 2009 041 501 B3, for example, the design of a metal-optical mirror telescope with rotationally symmetrical aspherical surfaces using micro-machined reference and contact structures on the mirror bodies is described. A prerequisite for the application of the mentioned manufacturing and assembly strategy is the use of micromachinable materials for optical and mechanical components. The reason for this is especially the necessary accuracy in the positional assignment between optical and mechanical surfaces on the mirror body partially in the sub-micrometer or angular second range, which is produced in the state of the art by machining in a common machine set-up on an ultra-precision processing machine. Each additional clamping or disassembly process reduces the accuracy of the positional assignment between the optical and mechanical coordinate systems. Furthermore, the required high quality of the positional relationship can only be guaranteed if after the ultra-precision machining process no further machining processes are used that significantly change the accuracy of the positional relationship. Primarily used materials for such mirror bodies are e.g. different aluminum alloys or nickel-phosphorus.

For some applications, especially in astronomy, earth observation, remote sensing and microlithography, the use of metallic materials, e.g. aluminum alloys, for the construction of the optical mirror system is only a limited option due to the thermal and mechanical properties of the metallic materials. For example, the increased coefficient of thermal expansion of a metallic material compared to optical glasses and glass ceramics limits the application for high temperature changes or gradients. For astronomical instruments at cryogenic application temperatures, therefore, brittle-hard glass ceramics with an exemplary coefficient of thermal expansion <0.03*10⁻⁶1/K are often used. For extraterrestrial applications, the specific stiffness of metallic materials is a particular limitation. In order to survive vibration and shock loads during the launch into space without damage, the mirror bodies must comprise a high stiffness. At the same time, a low component mass of the mirror bodies is often desirable. Therefore, brittle ceramic materials such as silicon carbide or beryllium compounds are often used as base materials for the construction of the mirror bodies.

The advantages of brittle-hard materials for use as materials for optical mirror bodies under increased structural or thermal loads are countered by a more complex processing technique using grinding, polishing and correction techniques compared to metallic materials. Brittle-hard mirror bodies are typically accommodated in a holding structure, often metallic, by suitable mounting techniques and then placed and aligned in the optical system's beam path. The transfer of the optical coordinate system of the mirror surface to the mechanical coordinate system of the holding structure is characterized by the achievable quality of the joining process. Therefore the tolerances in the positional assignment are typically one order of magnitude higher than the quality of micromachined dimensional references of a metal-optical system. An efficient assembly of individual components to a common mirror system based on the model of a plug-in assembly is not solved for brittle-hard mirror materials in the current state of the art.

An object to be solved is therefore to specify a method for the production of an optical system that allows a simplified assembly of an optical component made of a brittle-hard material into the optical system.

According to at least one embodiment, the method of manufacturing an optical system with an optical component comprising a brittle-hard material produces at least one optical functional surface on the optical component. The optical component can be a mirror, for example, whereby the optical functional surface is a mirror surface. Alternatively, it is also possible that the optical component is a lens or a diffractive optical element, whereby the optical functional surface is a lens surface or a surface with a diffractive structure.

In a further step of the method, the optical component is mounted on a processing machine. By means of at least one machining tool of the processing machine, several reference surfaces and mounting surfaces are produced at the optical component or at at least one insert body permanently connected to the optical component. The reference and mounting surfaces are produced in particular by ultra-precision machining using the machining tools of the processing machine. The reference surfaces are intended in particular to define a coordinate system for measuring the shape and position of the optical component. The mounting surfaces are intended to serve as a mounting or contact surface for the later assembly of the optical component into the optical system. After ultra-precise machining on the processing machine, the reference and mounting surfaces are advantageously located in a shape and position deviation in the order of magnitude of the positioning accuracy of the processing machine and thus define a coordinate system for which the optical functional surface can be measured relative with respect to the shape and the position.

In a subsequent step, the shape and position of the optical functional surface is measured in a coordinate system related to the reference surfaces. The measurement is performed, for example, by a tactile or optical measuring process.

In a further step, a correction process is carried out at least once, in which the shape and position deviation of the optical functional surface relative to the reference and assembly surfaces is reduced. This step is repeated as often as necessary until the shape and position of the optical functional surface conforms to a specification within a given tolerance range.

Subsequently, the optical component is installed at the mounting surfaces into a housing structure of the optical system. The method enables a simplified assembly of the optical component into the mechanical housing structure of the optical system by means of the advantageous ultra-precision machined mounting surfaces. Since the shape and position of the optical functional surface of the optical component relative to the mounting surfaces is known with high precision after the method has been carried out, the optical component can easily be mounted into the optical system at the mounting surfaces in an at least almost optimal position. This is particularly advantageous if the mechanical mounting surfaces on the housing structure have also been manufactured by ultra-precise machining and also comprise high dimensional and positional accuracy. The optical system can be a telescope or a device for earth or remote sensing, for example. In particular, the optical system may be intended for applications in space.

According to at least one embodiment, the brittle-hard material of the optical component is a glass, a ceramic or a glass-ceramic. In particular, the brittle-hard material can be a glass ceramic with a negligible coefficient of thermal expansion or a ceramic, for example silicon carbide or a beryllium compound. The reference surfaces and/or the mounting surfaces can be produced by the method, especially directly in the brittle-hard material of the optical component. Alternatively, the reference surfaces and/or the mounting surfaces can be produced at the at least one insert body permanently attached to the optical component.

The reference and/or mounting surfaces are preferably produced by a micro-machining turning, milling or planing process. Alternatively, the reference and/or mounting surfaces are produced by a grinding process or by an ultrasonic-supported turning or milling process.

According to an embodiment of the method, the optical component is placed on a machining device, which comprises further reference surfaces, before the reference and mounting surfaces are manufactured. In a preferred variant of the method, the optical component is also arranged on the machining device during the method step of measuring the shape and position of the optical functional surface, whereby the shape and position of the optical functional surface is measured relative to the further reference surfaces. In a variant of the method, the optical component is already arranged on the machining device during the production of the optical functional surface and/or during a subsequent shape correction or polishing process of the optical functional surface.

The correction processing of the optical surface is preferably carried out by a computer-controlled polishing process or by an ion beam tool.

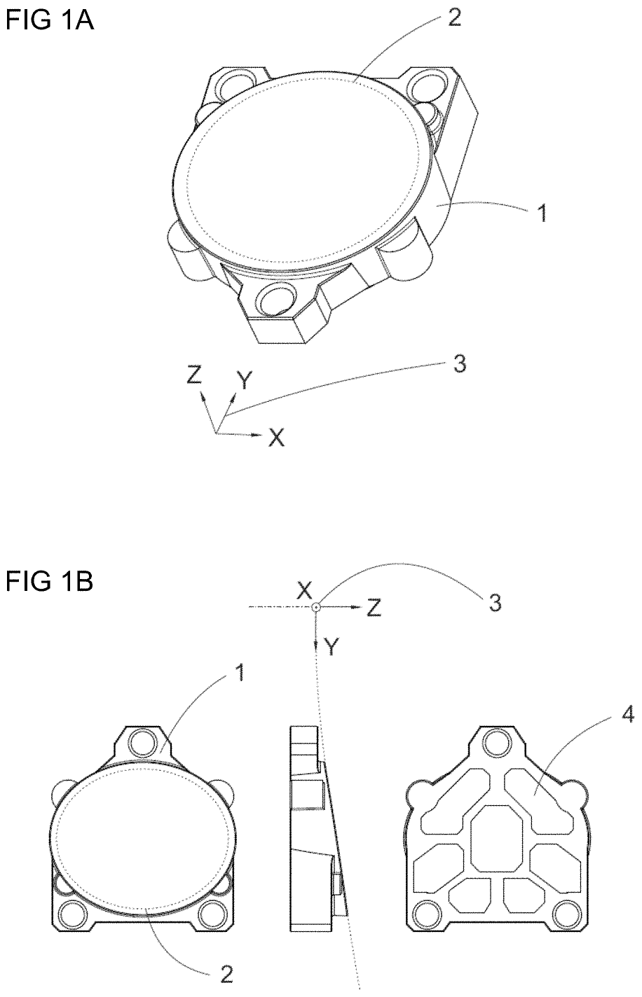

In the following, the invention shall be exemplarily explained in more detail. The figures depicted show examples of a design variant of the method for manufacturing an optical component and an optical system with the optical component, whereby the optical component is an optical mirror body made of a brittle-hard material. Typical materials for the mirror body include optical glasses and glass ceramics, optical crystals and ceramic materials. The method of manufacturing the components including exemplary embodiments for the advantageous design of a complete process chain as well as a system assembly are explained in more detail in the following in connection with FIGS. 1 to 10.

In the Figures:

FIG. 1A shows a mirror body made of a brittle-hard material in isometric view,

FIG. 1B shows the mirror body in another view,

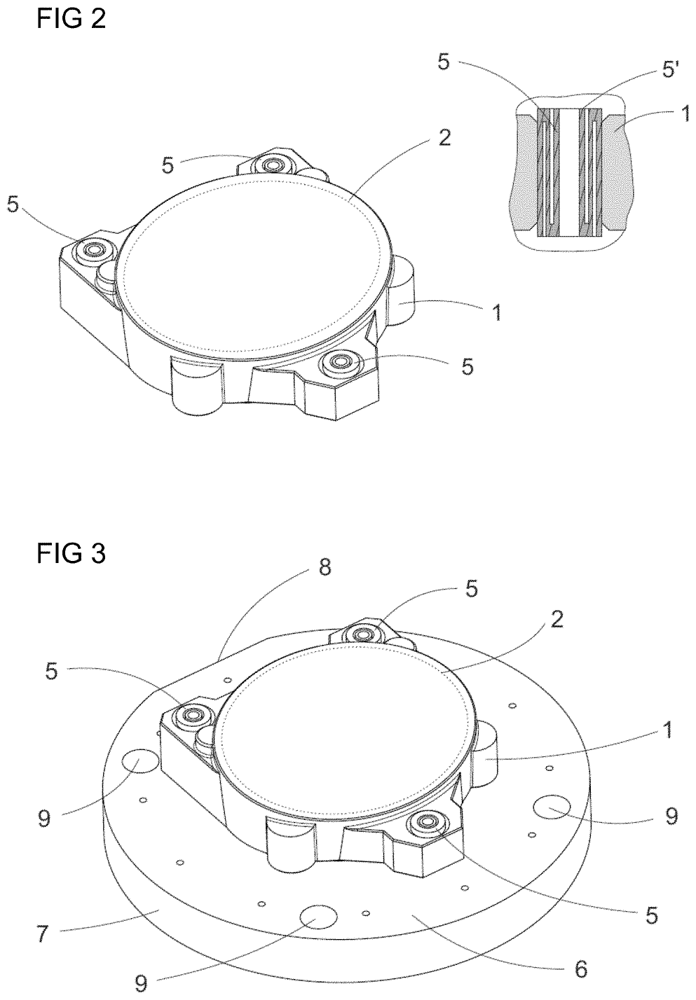

FIG. 2 shows the mirror body after inserting an insert body,

FIG. 3 shows the mirror body on a machining device,

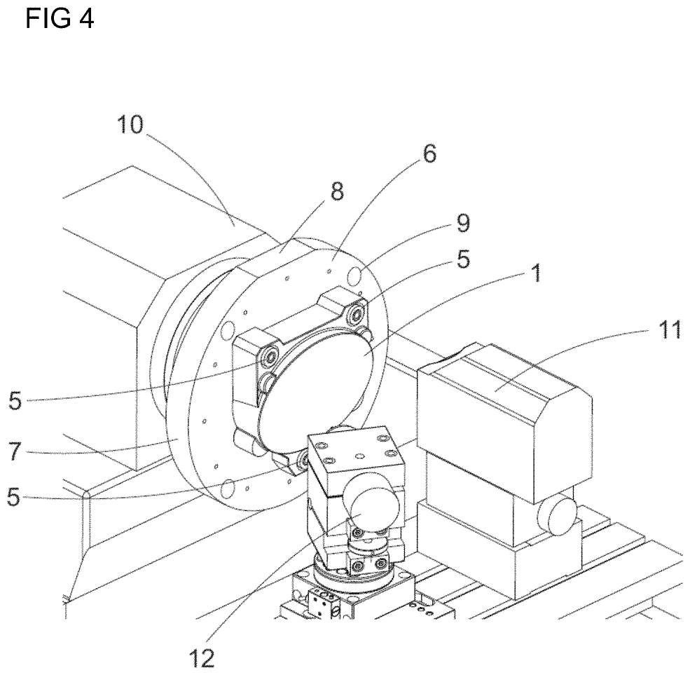

FIG. 4 shows the assembly formed by the mirror body and the machining device on a processing machine,

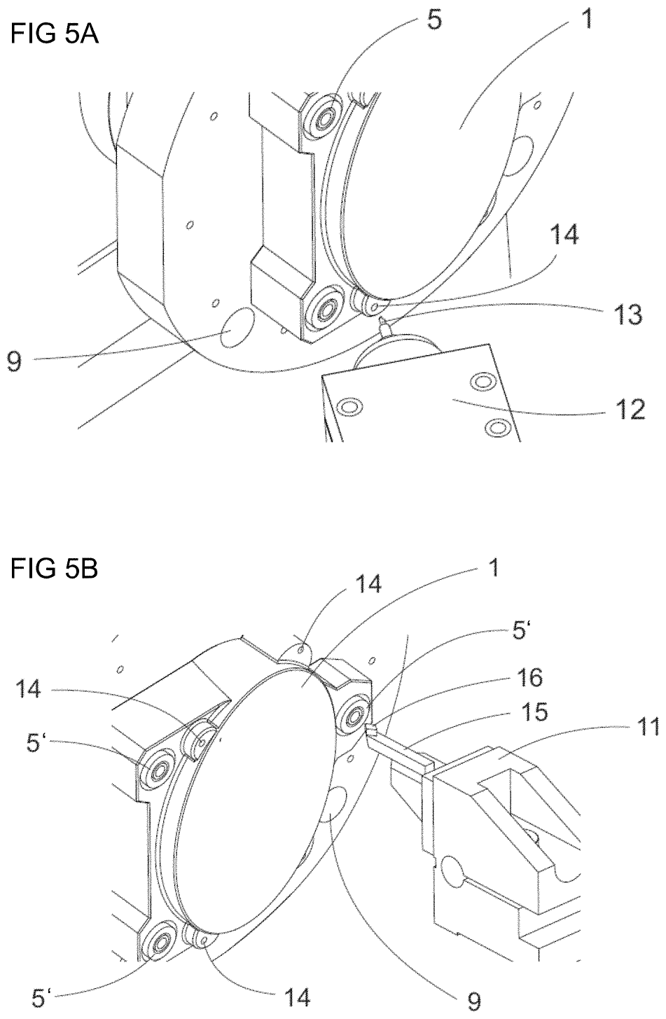

FIG. 5A shows a detailed view of the production of reference surfaces,

FIG. 5B shows a further detailed view of the production of reference surfaces,

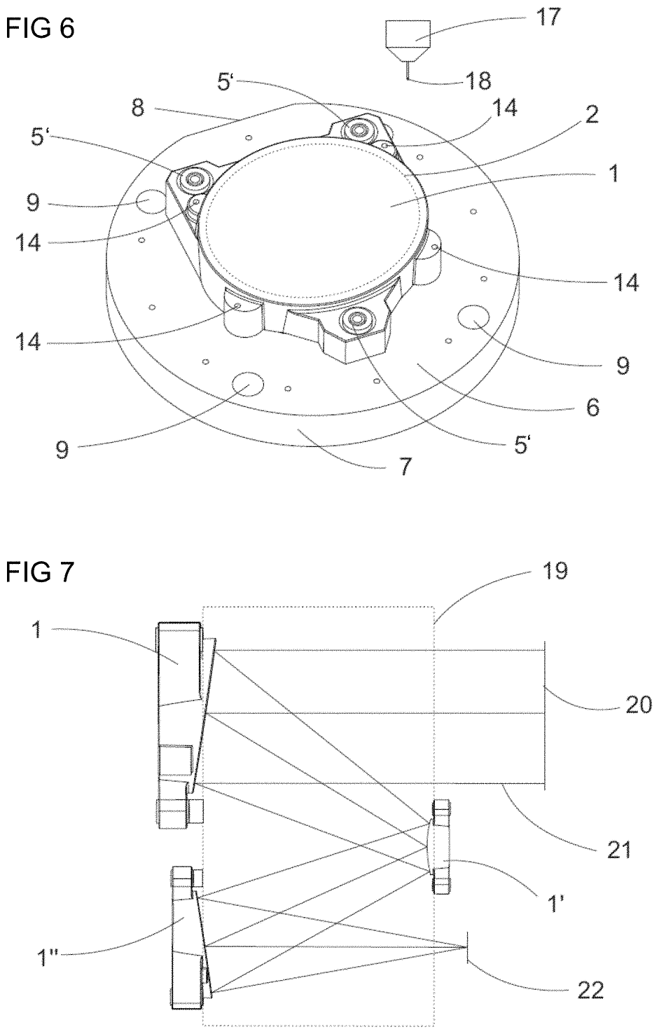

FIG. 6 shows the mirror body when measuring in a high-precision measuring device,

FIG. 7 shows a side view of an optical reflecting telescope in which the mirror body is mounted,

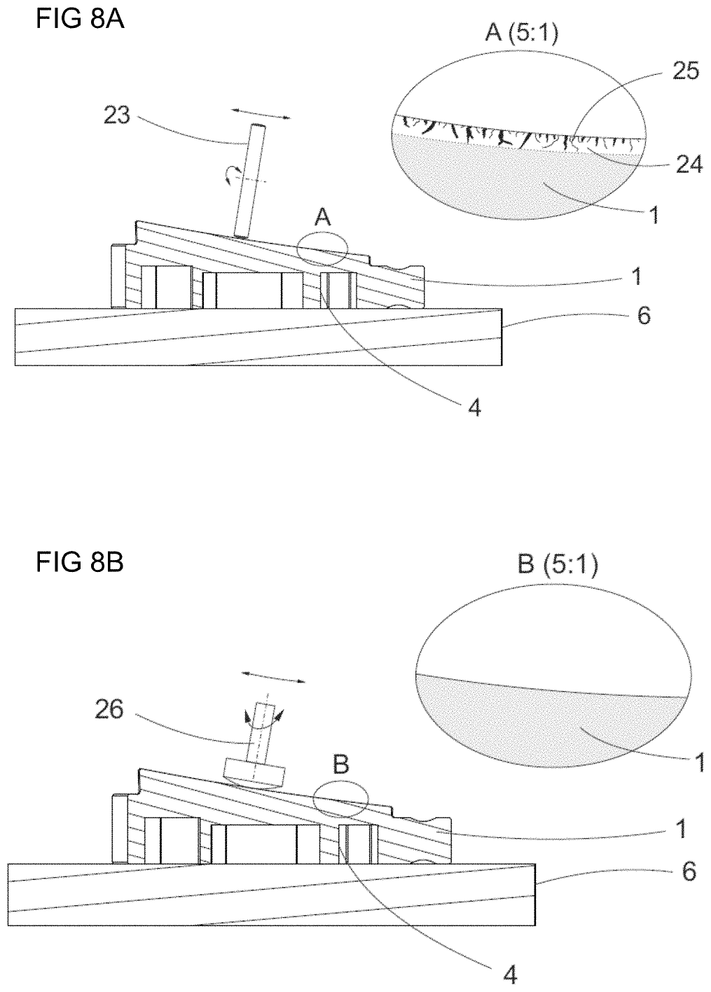

FIG. 8A shows a sectional view of a fine grinding process for the production of the optical functional surface for an embodiment of the method,

FIG. 8B shows a sectional view of the polishing and shape correction of the optical functional surface for an embodiment of the method,

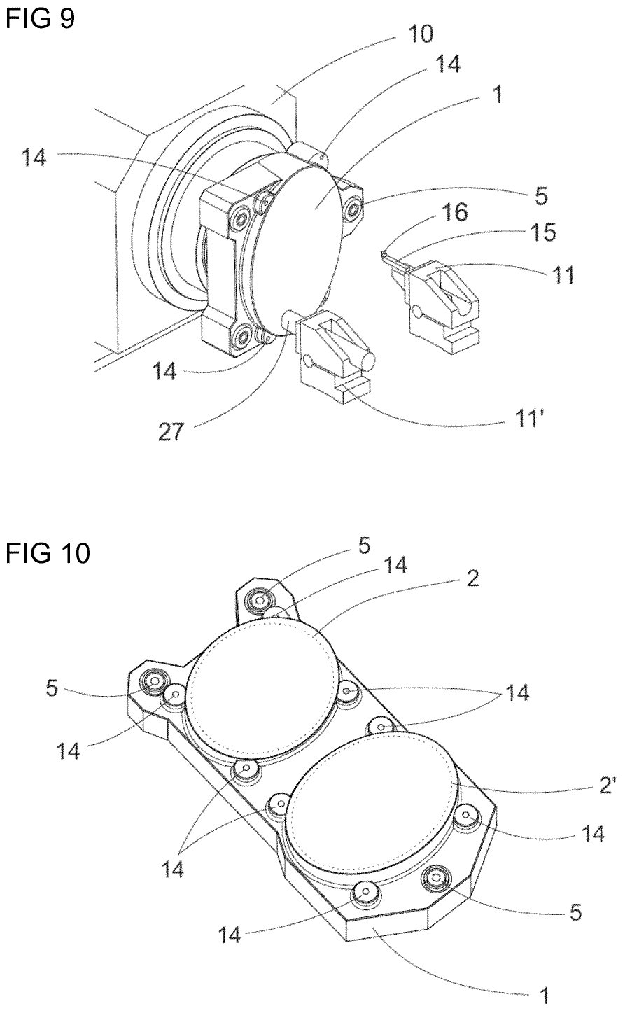

FIG. 9 shows the mirror body on the processing machine for an embodiment of the method, and

FIG. 10 shows an example of an optical component with two optically effective functional surfaces in a further embodiment of the method.

Similar or similarly acting components are marked with the same reference signs in the figures. The components shown and the proportions of the components to each other are not to be considered as true to scale.

FIGS. 1A and 1B illustrate a mirror body as an example of the optical component 1 produced by the method. However, the method can also be applied without restriction to the manufacture and subsequent assembly of other optical components made of brittle-hard material, e.g. refractive lens systems. The optical component 1 like the mirror body in FIG. 1A can be produced by a shaping cutting or contouring process and is then advantageously already available in a geometry close to the nominal geometry. The optical component 1 made of a brittle-hard material can be processed in particular by contour grinding or ultrasonic-assisted contour milling of the geometric outer surfaces of the mirror body, followed by possible cleaning and measuring steps.

In this method, an optical functional surface 2 of the optical component 1 is produced. In the example shown here, optical component 1 is a mirror body that comprises a mirror surface as optical functional surface 2. The mirror surface is manufactured in such a way that it meets predetermined shape and roughness requirements for optical applications in the area of the free aperture. The optical functional surface 2 and its free aperture are usually defined with respect to a global or local coordinate system 3. In the example in FIG. 1A, the free aperture of the mirror surface is an off-axis surface section with respect to the Cartesian coordinate system 3 and comprises a concave surface shape. The method can be applied with particular advantage to axial and off-axial optical functional surfaces 2 with aspherical or free-formed surface geometry. Without restriction, however, the method according to the invention can also be applied to the manufacture and assembly of an optical component of planar or spherical optical functional surfaces.

FIG. 1B illustrates the precontoured optical component 1 already shown in FIG. 1A in an additional view. The optical component 1 can have a contoured back side which comprises e.g. cooling structures. As shown in FIG. 1B, the back side of the optical component 1 may have recesses 4, e.g. ground or milled areas, which are advantageous for reducing the weight of the optical component and thus forming a lightweight structure.

The shaping of the optical functional surface 2 of the optical component 1 is typically achieved by a separating manufacturing process and can take place in several process steps. The optical functional surface 2 can be processed in particular by a grinding process and subsequent polishing process. Due to the brittle-hard material properties, a sequence of grinding processes can be applied with advantage, especially based on so-called cup-shaped or disc tools on CNC-controlled grinding machines. In the grinding processes, the grain sizes of the grinding tools used are advantageously successively reduced, starting from the so-called pre-grinding to the finest grinding.

After the grinding process, a matt surface with increased surface roughness for optical applications remains, which may comprise mechanical tensions and cracks in a near-surface layer (so-called “sub-surface damage”). To reduce the surface roughness and to eliminate the sub-surface damage, the optical functional surface 2 can be polished afterwards, in particular by using different polishing processes. The material removal required in the grinding and polishing process depends on the surface quality after the pre-contouring process or the selected process parameters and materials in the processes. As a typical order of magnitude for a material removal in the grinding process, a layer thickness of 50 μm-500 μm should be mentioned at this point, for subsequent polishing processes the required material removal is often in the range of 10 μm-50 μm. It should also be pointed out that grinding and polishing processes are usually carried out on different CNC-controlled processing machines with limited accuracy of positioning of the machining tools, so that in particular the position of the optical functional surface 2 in relation to the coordinate system 3 and the outer contours of the optical component 1 can vary in the range of several tens of micrometers up to millimeters.

FIG. 2 shows the optical component 1 including the optical functional surface 2, which after the production process described above is available in a quality regarding surface shape and roughness close to the final specification. When using CNC-supported grinding and polishing processes known per se, a deviation of the optical functional surface 2 after an optimized fit to the nominal shape (so-called “best-fit”) can be approximately 5 μm, measured from the point of highest to the point of lowest deviation.

In the following, the method is intended to generate a highly accurate positional reference between the reference and mounting surfaces and the optical functional surface 2 by machining different reference and mounting surfaces on a processing machine, in particular an ultra-precision processing machine. In the example in FIG. 2, the optical component 1 has several insert bodies (inserts) 5, which are inserted, for example by a joining process, into holes provided in the optical component 1 and comprise surfaces that form mounting surfaces 5′. After inserting the insert bodies 5, their relative position to the optical mirror surface 2 can be determined by a measuring process. The mounting surfaces 5′ can be processed by a micro-machining method or by grinding. FIG. 2 shows a section through an exemplary insert body 5 in a detailed view. It is possible, for example, to configure the insert body 5 as a flexure hinge structure in order to relax mechanical stresses after mounting the optical component 1 via the mounting surfaces 5′ and to minimize deformation of the optical functional surface 2.

FIG. 3 illustrates an advantageous embodiment of the method in which the optical component 1 including the insert bodies 5 is mounted on a machining device 6. The optical component can be mounted by different clamping techniques, whereby low-stress clamping techniques based on vacuum clamping or bonding are preferred. Insofar as the geometries of the optical component 1 and the machining device 6 allow it, the optical component can also be picked up using the insert bodies 5. In a particularly advantageous design, the machining device 6 already has various reference surfaces for referencing in subsequent measuring and machining processes, which are advantageously produced by micromachining techniques on a processing machine, in particular by ultra-precision machining. As an example, FIG. 3 shows reference surfaces 7, 8, 9 at the machining device 6 in the form of a machined circumferential surface 7 for lateral referencing of the center point, a plane surface 8 on the circumferential surface for referencing and fixing the axial rotation, and four ball segments 9, which are advantageously produced by a micro-machining process. The position of all reference surfaces 7, 8 and 9 of the machining device 6 can be determined with high accuracy on a tactile, three-dimensional coordinate measuring machine. Likewise, the position of the mirror body 3 or its optical functional surface 2 can be determined in high quality by using tactile or optical measuring methods after being mounted on the machining device 6.

FIG. 4 shows the optical component 1 on the machining device 6 after being mounted on a processing machine 10, which is in particular an ultra-precision processing machine. The processing machine 10 is, for example, an ultra-precision lathe with a rotating main spindle and several linearly operating translation axes. Alternatively, the processing machine 10 can comprise other machining tools and/or axis arrangements. In addition to ultra-precision turning processes, ultra-precision milling, planing or grinding processes can also be applied, for example. Particularly preferred is machining on an ultra-precise processing machine, which typically comprises positioning uncertainties of the linear axes used below one nanometer.

FIG. 4 illustrates a setup of two machining tools 11, 12 on a linear axis of the processing machine 10, where a first machining tool 11 is designed as a turning tool for micro-machining and a second machining tool 12 as a grinding spindle, especially for machining a brittle-hard material. Both machining tools 11, 12 have a precise referencing within the machine coordinate system of the processing machine 10, which means that the relative position of the machining tools 11, 12 is known with a precision well below one micrometer.

Advantageously, the design of the machining device 6 in FIG. 4 is such that the reference and mounting surfaces can be machined at both the machining device 6 and the optical component with the machining tools 11, 12. For the arrangement shown in FIG. 4 as an example, this applies in particular to the reference surfaces 7, 9 of the machining device 6 as well as the mounting surfaces 5′ and further reference surfaces on the optical component 1. Due to possible contamination caused by e.g. dust and chips during ultra-precise machining, it may be advantageous to protect the optical functional surface 2 of the optical component 1 during the mounting on the processing machine 10 by a varnishing which is preferably adapted to the material of the optical functional surface 2.

FIG. 5A shows a detailed view of the optical component 1 on the processing machine while processing reference surfaces 14 at the mirror body. It is advantageous to know the position of optical component 1 within the machine coordinate system of the processing machine, for example, by means of a preceding measuring process. The method now provides for the creation of defined reference and mounting surfaces at the optical component 1 by machining with a machining tool 13. The reference and mounting surfaces can be produced with the method in high quality with regard to their shape and position according to typical manufacturing tolerances of an ultra-precise processing machine. As an example, the reference surfaces 14 in FIG. 5A are designed as concave ball segments at specially provided positions on the optical component 1. The ball segments 14, for example, are manufactured directly in the brittle-hard material of the optical component 1 by machining with a grinding tool 13, which is mounted on a grinding spindle 12. For this purpose, either the optical component 1 or the grinding spindle 12 are moved separately or together in a defined manner to create a suitable cutting path. The grinding tool 13 thus moves in the described cutting path relative to the optical component 1 and simultaneously rotates at high peripheral speed so that the sphere segments 14 are successively ground in on optical component 1. The sphere segments 14 produced in this way have a very precise positional reference to one another and thus embody a highly precise coordinate system which has a certain, but measurable deviation from the coordinate system of optical component 1 in the degrees of freedom adapted to the geometry of the optical functional surface 2.

Furthermore, the method produces mounting surfaces, in particular for mounting the optical component 1 in an optical system, without reclamping or loosening the optical component 1 from the processing machine 10. FIG. 5B shows an example of the micromachining of mounting surfaces 5′ on, for example, metallic insert bodies 5 as mechanical coupling elements using a turning tool 11. In the field of micromachining, diamond is often used as a cutting tool due to its excellent cutting properties.

As an example, FIG. 5B shows a diamond tool 16 on a tool holder 15, which is held by a tool fixture 11. A cutting path is created by a relative movement between the optical component 1 and the diamond tool 16 and then at least one mounting surface 5′ is machined on the insert bodies. The manufactured mounting surfaces 5′ are available after machining with high shape and position quality corresponding to the manufacturing quality of the processing machine 10.

Furthermore, when using the machining device 6, reference surfaces 7, 9 can also be produced on the machining device 6, in particular by a turning, milling or grinding process. In FIG. 5B, the shown sphere segments 9 or the circumferential cylindrical surface 7 of the machining device 6 are such reference surfaces.

Due to the high manufacturing quality, all reference and mounting surfaces produced with the processing machine 10 are present with very small shape deviations and very small relative positional deviations to each other. By previously configuring different machining tools, such as grinding tool 12 or turning tool 11, which are shown as examples in FIGS. 5A and 5B, the reference and mounting surfaces produced by different tools also have an excellent relative positional reference. In the method described above, the machining steps have in particular created reference and mounting surfaces of high quality and position, which define a new coordinate system and specify the mounting position of optical component 1 in a housing structure of an optical system or optical system in various degrees of freedom. Since the optical functional surface 2 itself is not machined on the processing machine 10, the positional deviation of the functional surface 2 within the coordinate system generated by the machining processes depends on the quality of the previous production of the optical functional surface 2 on the optical component 1 and the assembly accuracy of the optical component 1 on the processing machine 10. When using a machining device 6, which has also been ultra-precisely machined before, the optical component 1 can first be picked up with a small positional deviation on the machining device 6 and then, after pickup on the processing machine 10, be referenced with respect to the latter.

FIG. 6 illustrates the mirror body 1 on the machining device 6 within a measuring machine which measures the shape and position of elements on the optical component 1 by means of a tactile measuring method with a measuring head 17 and a probe 18. In an advantageous design, the machining device 6 used during ultra-precise machining is used as a measuring device within the measuring process. The measuring process now makes it possible to measure the position and shape of the optical functional surface 2 relative to the ultra-precision machined reference and mounting surfaces 14, 5′ with high quality. At the same time, a position check relative to the reference surfaces 7, 8, 9 of the machining device 6 can be performed. The result of the measuring process is, on the one hand, information about the positional deviation of the optical functional surface 2 relative to the reference and mounting surfaces 5′, 14, and, on the other hand, information about a remaining shape error of the optical functional surface 2. In addition to the tactile measuring principle shown as an example using a measuring head 17 with probe 18, the application of optically effective measuring principles is also possible. For example, the optical functional surface 2 can be measured by an interferometric test procedure in order to determine the shape error with high measuring accuracy or to determine a relative position error of the optical functional surface 2 to the reference surfaces 9, 14 produced at the optical component 1 or at the machining device 6.

The method also provides for minimizing the shape and positional deviations of the optical functional surface 2 determined as a result of the measuring process by subsequent correction processing, in particular until a given specification is achieved within a given tolerance range. In general, the quality of the production of the optical functional surface 2 and reference and mounting surfaces 5′, 14 should be sufficiently good to correct the remaining shape and position deviations by, for example, a computer-controlled shape correction process in a defined number of process steps. For this purpose, for example, polishing and correction techniques based on subaperture polishing tools or an ion beam can be applied. Typically, only a few micrometers of material are removed from the optical functional surface 2. At the same time, correction processing allows the optical functional surface 2 to be produced with a shape and/or position deviation of a few nanometers from the theoretical target shape. An advantage of the method is that the correction machining is now relative to the manufactured reference and mounting surfaces 5′, 14. By iterative application of measuring and correction processes a deterministic reduction of remaining shape and position errors is possible. The relative position of the optical functional surface 2 can be determined in each iteration with high accuracy by a tactile or optical measuring process.

FIG. 7 shows an example of the assembly of the optical component 1 into an optical system during the method. In FIG. 7, the optical system is an optical reflecting telescope comprising optical components 1, 1′, 1″, which are three mirror bodies 1, 1′, 1″. The reflecting telescope is configured to image an object from an object plane 20 to an image plane 22. For a better understanding, the optical beam path 21 in the optical system is shown as an example.

By manufacturing the optical components 1, 1′, 1″ according to the method described above, the assembly of the optical components 1, 1′, 1″ into the optical system is advantageously simplified considerably. The optical system advantageously has a housing structure 19, which comprises mechanical stop surfaces for the assembly of the optical components 1, 1′, 1″. The mechanical locating surfaces for the optical components 1, 1′ and 1″ on the housing structure 19 are advantageously machined by an ultra-precise machining process. For example, the mechanical locating surfaces can be micromachined by mounting the entire housing structure 19 on the processing machine 10 described above. After machining, the mechanical locating surfaces are available on the housing structure 19 with a high degree of shape and position accuracy. Since the position of the optical functional surfaces of the optical components 1, 1′, 1″ relative to the mounting surfaces 5′ of the optical components 1, 1′, 1″ is known with high precision after the previously described manufacturing process has been carried out, the system assembly of the complete telescope is reduced to a stop of the optical components 1, 1′, 1″ against the common housing structure 19. The precise position information enables the installation of the optical components 1, 1′, 1″ close to their optimal position. In most cases a direct optical system test can be performed, for example with the help of an interferometer, in order to measure wavefront information of the optical system, for example. If necessary, an iterative manipulation and adjustment of the optical components 1, 1′, 1″ along the open degrees of freedom of the housing structure 19 is performed until a defined system specification is reached. In any case, by applying the method described here, the adjustment is deterministic and usually completed in a few iterations.

In FIG. 8A an advantageous embodiment of the method is shown, where the machining device 6 is already used during the fabrication of the optical functional surface 2 of the optical component 1. The optical functional surface 2 is produced by grinding, for example. FIG. 8A shows a sectional view through optical component 1, which comprises recesses 4 for the formation of a lightweight structure, as well as a magnification A of the surface of optical component 1. Optical component 1 and machining device 6 are connected by a joining process, such as a temporary bonding process. For processing, the optical component 1 is referenced and centered via reference surfaces, such as a circumferential cylindrical surface on the machining device 6. This is followed, for example, by a fine grinding process using a grinding tool 23 by mechanically machining the optical functional surface 2 of optical component 1. After grinding, the optical component can be measured in a measuring process similar to FIG. 6. The ultra-precise machining device 6 including its reference surfaces 7, 8, 9 can be advantageously used to measure the relative position and shape of the optical surface 2 in the coordinate system of the machining device 6. Subsequently, a correction grinding of the optical functional surface 2 can be performed. Since this advantageous embodiment of the method also allows the mirror body 1 to be picked up and referenced in the processing machine 10 as shown in FIG. 4, the use of the machining device 6 in the pre-grinding and fine grinding process significantly reduces possible machining errors and iterations. After the grinding process, however, a near-surface layer 24 remains, within which the optical functional surface 2 is characterized by sub-surface damage and microcracks 25 in the brittle-hard material. At this stage of production, it is not yet possible to use it as an optical functional surface. To remove the sub-surface damage shown in magnification A within FIG. 8A, the optical functional surface 2 is polished out in a subsequent polishing process, whereby several micrometers of material can be removed.

FIG. 8B illustrates an example of the optical component 1 in a sectional view during the polishing process. In an advantageous version of the method, the machining device 6 is also used in the polishing process, so that all preliminary processes for the production of the optical surface 2 can be referenced to the coordinate system of the machining device 6. In the polishing process, a polishing tool 26 processes the optical functional surface 2 of the optical component 1 until the near-surface and sub-surface-damaged layer 24 shown in FIG. 8A is completely removed (see magnification B in FIG. 8B). Analogous to the grinding process in FIG. 8A, an iterative application of measuring and machining processes can be performed with the aid of the machining device 6 in order to produce the shape and relative position of the optical functional surface 2 in the best possible way. As a result of the polishing process shown in FIG. 8B, a precontoured optical component is obtained as shown in FIG. 1A and FIG. 1B. Subsequently, the optical component 1 passes through the manufacturing process for producing the reference and assembly surfaces as described and illustrated in FIGS. 2 to 6.

A further embodiment of the method, which does not require the use of a machining device 6, is shown in FIG. 9 as an example. The optical component 1 made of brittle-hard material, which is a mirror body as in the previous examples, is recorded on an ultra-precise processing machine 10. The initial position and referencing of the optical functional surface of optical component 1 within the machine coordinate system is performed in this embodiment without the aid of an ultra-precise machining device and is accomplished by measuring the optical functional surface with a measuring head 27 in a holding device 11′. After calibration, the deviation from the optimum position is determined by fitting the measured surface data (so-called “best-fit”). Then the mirror body 1 is optionally adjusted within the machine environment. After the position of the mirror body 1 within the coordinate system of the processing machine 10 has been determined with sufficient accuracy, the reference and mounting surfaces 14, 5′ on the optical component 1 are produced by a machining tool, such as a diamond turning tool 16 within a turning process.

The method is not limited to the production of optical components with only one optical functional surface 2. As an example, FIG. 10 shows an optical component 1, which is an optical mirror module with two optical functional surfaces 2, 2′. In this method, both functional surfaces 2, 2′ are manufactured in a common machine setting and are advantageously referenced in the machining and measuring processes using a common ultra-precise machining device 6. One step of the method is again the production of the reference and mounting surfaces at the optical component 1 by machining on a processing machine 10. In this step, for example, reference surfaces 14 are produced in the form of spherical segments for measuring the optical functional surfaces 2, 2′ within a measuring machine, and mounting surfaces 5′ for integrating the optical component 1 into a mechanical housing structure 19 of an optical system. The optical system can be a telescope, for example. The processing of several optical functional surfaces 2, 2′ increases the effort for manufacturing and measuring technology, but significantly reduces the effort for the assembly into the optical system by reducing the open degrees of freedom for alignment.

The invention is not limited by the description based on the exemplary embodiments. Rather, the invention comprises each new feature as well as each combination of features, which in particular includes each combination of features in the patent claims, even if this feature or this combination itself is not explicitly specified in the patent claims or exemplary embodiments.

### LIST OF REFERENCE SIGNS

1 optical component
2 optical functional surface
3 coordinate system
4 recess
5 insert body
5′ mounting surface
6 machining device
7 reference surface
8 reference surface
9 reference surface
10 processing machine
11 machining tool
11′ holding device
12 machining tool
13 machining tool
14 reference surface
15 tool holder
16 diamond tool
17 measuring head
18 probe
19 housing structure
20 object plane
21 beam path
2 image plane
23 sanding tool
24 near-surface layer
25 micro cracks
26 polishing tool
27 measuring head

1. A method of manufacturing an optical system having an optical component comprising a brittle-hard material, the method comprising:
producing at least one optical functional surface at the optical component,
mounting the optical component on a processing machine and producing several reference surfaces and mounting surfaces at the optical component or at least one insert body permanently connected to the optical component by at least one machining tool of the processing machine,
measuring the shape and position of the optical functional surface in a coordinate system related to the reference surfaces,
performing a correction machining at least once, in which the shape and position deviation of the optical functional surface relative to the reference and mounting surfaces is reduced, and
installing the optical component in a housing structure of the optical system at the mounting surfaces.

2. The method according to claim 1, wherein the brittle-hard material is a glass, a ceramic or a glass-ceramic.

3. The method according to claim 1, wherein at least one of the reference surfaces and the mounting surfaces is produced in the brittle-hard material of the optical component.

4. The method according to claim 1, wherein at least one of the reference surfaces and the mounting surfaces is produced at the at least one insert body permanently attached to the optical component.

5. The method according to claim 1, wherein at least one of the reference surfaces and the mounting surfaces is produced by a micro-machining turning, milling or planing process.

6. The method according to claim 1, wherein the production of at least one of the reference surfaces and the mounting surfaces is carried out by a grinding process or ultrasonic-supported turning or milling process.

7. The method according to claim 1, wherein at least one of the reference surfaces and the mounting surfaces is produced by a laser-assisted turning or milling process.

8. The method according to claim 1, wherein the optical component is arranged on a machining device which comprises further reference surfaces prior to the production of the reference and mounting surfaces.

9. The method according to claim 8, wherein the optical component is arranged on the machining device when measuring the shape and position of the optical functional surface, and wherein the shape and position of the optical functional surface is measured relative to the further reference surfaces.

10. The method according to claim 8, wherein the optical component is arranged on the machining device during at least one of the production of the optical functional surface and a subsequent shape correction or polishing process of the optical functional surface.

11. The method according to claim 1, in which the correction processing of the optical functional surface is carried out by a computer-controlled polishing process or by an ion beam tool.
